(19) United States
(12) Patent Application Publication
(10) Pub. No.: US 2005/0053268 A1
(43) Pub. Date: Mar. 10, 2005

(54) Method for locating the edge of an object

(76) Inventor: Edmond Joseph Breen, Berowra (AU)

Correspondence Address: FROMMER LAWRENCE & HAUG, 745 FIFTH AVENUE- 10TH FL., NEW YORK, NY, 10151, US

(21) Appl. No.: 10/845,672

(22) Filed: May 14, 2004

Related U.S. Application Data
(63) Continuation-in-part of application No. PCT/AU02/01556, filed on Nov. 15, 2002.

(30) Foreign Application Priority Data
Nov. 16, 2001 (AU) PR 8917

(51) Int. Cl. G06K 9/00

(52) U.S. Cl. 382/128

(57) ABSTRACT

A method for accurately determining the boundaries of an object, particularly a gel slab includes the steps of creating a binary image of the object, the binary image having a central region a boundary region and an outside region with the boundary region encompassing the gel boundary; and performing a homotopic thinning of the binary image, iteratively until no more pixels can be removed. For optimum results, the homotopic thinning iteration is based on a grey scale image of the gel edge and surrounding area, and is most preferably based on an edge threshold image. This involves producing a grey scale edge image of the gel having high response values or intensity where local intensity changes are highest within the image and performing a grey scale controlled homotopic thinning of the binary image in which the pixels which can be removed homotopicaly from the binary image are ordered and the pixel which is removed is that which corresponds in location to the pixel which has the smallest edge/intensity value in the grey scale edge image of the gel. This process is continued iteratively until no more pixels can be removed.

### FIELD OF THE INVENTION

This invention relates to a method for locating the edge of an object. It has particular application to locating the edge of a two dimensional electrophoretic gel but is not limited to that application.

### BACKGROUND OF THE INVENTION

One dimensional and two dimensional (2-D) gel electrophoresis are common techniques used to separate macromolecules from mixtures of macromolecules such as proteins from plasma samples and the like. In 2-D gel electrophoresis separation is undertaken sequentially through orthogonal axes, the first separation commonly being carried out in an IPG strip, with the second dimension separation being carried out in a gel slab. The macromolecules, typically proteins, are present as spots in the gel. The spots have to be removed from the gel and the proteins or other macromolecule forming the spot is then identified. In the separation of macromolecules, such as proteins by gel electrophoresis, the individual spots of protein or the like in the gel are visualised either by staining the spots with a dye that is visible under white light or by fluorescence of the protein itself. Historically, effort has been devoted to the identification and location of the protein spots within the gel.

However there has been no recognised activity which has been published relating to the determination of the boundary of the gel slab itself. Gels are quite soft and flexible and are easily damaged and distorted. The boundary of the gel may be quite irregular. The location of the boundary is however significant for the purpose of registration of the location of gel spots. Furthermore if the gel boundary could be accurately located this would allow automated gel calibration of molecular weight and isoelectric point.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this application.

### SUMMARY OF THE INVENTION

In a first broad aspect, the present invention provides a method for accurately determining the boundaries of an object such as a gel comprising the steps of:—
a) creating a binary image of the object, the binary image having a central region, a boundary region, and an outside region with the boundary region encompassing the boundary of the object; and
b) performing a homotopic thinning of the binary image, iteratively until no more pixels can be removed.

For optimum results, where the object is a gel, the homotopic thinning iteration is based on a grey scale image of the gel edge and surrounding area, and most preferably based on an edge threshold image. Thus, in a preferred aspect of the present invention, step (b) comprises the steps of:
c) producing a grey scale edge image of the gel having high response values or intensity where local intensity changes are highest within the image; and
d) performing a grey scale controlled homotopic thinning of the binary image in which the pixels which can be removed homotopicaly from the binary image are ordered and the pixel which is removed is that which corresponds in location to the pixel which has the smallest edge/intensity value in the grey scale edge image of the gel.

This process is continued iteratively until no more pixels can be removed.

Various methods can be used to produce an edge image of the gel, including Sobel, dilation erosion or laplacian.

In one preferred embodiment step a) involves the following steps
i) creating a crude binary image of the gel and cleaning the image to remove noise to provide an image that depicts the gel segmented into one group with the background as a second group, with the one group including the gel and gel boundary areas; and
ii) subtracting an erosion of the binary image from a dilation of the binary image.

The method is particularly suited to edge detection where the object is a gel of the type used in the chromatography process referred to as gel electrophoresis, however it could be used in other applications where edge detection is required for image segmentation or locating objects.

Step b) may utilise any suitable edge detection method such as a sobel method.

### BRIEF DESCRIPTION OF THE DRAWINGS

A specific embodiment of the invention will now be described by way of an example only and with reference to the accompanying drawings in which:—

FIGS. 1a to 1f are schematic diagrams illustrating various steps in a process embodying the present invention; and

FIGS. 2a and 2b illustrate a homotopic edge thinning process.

### DETAILED DESCRIPTION OF A PREFERRED EMBODIMENT

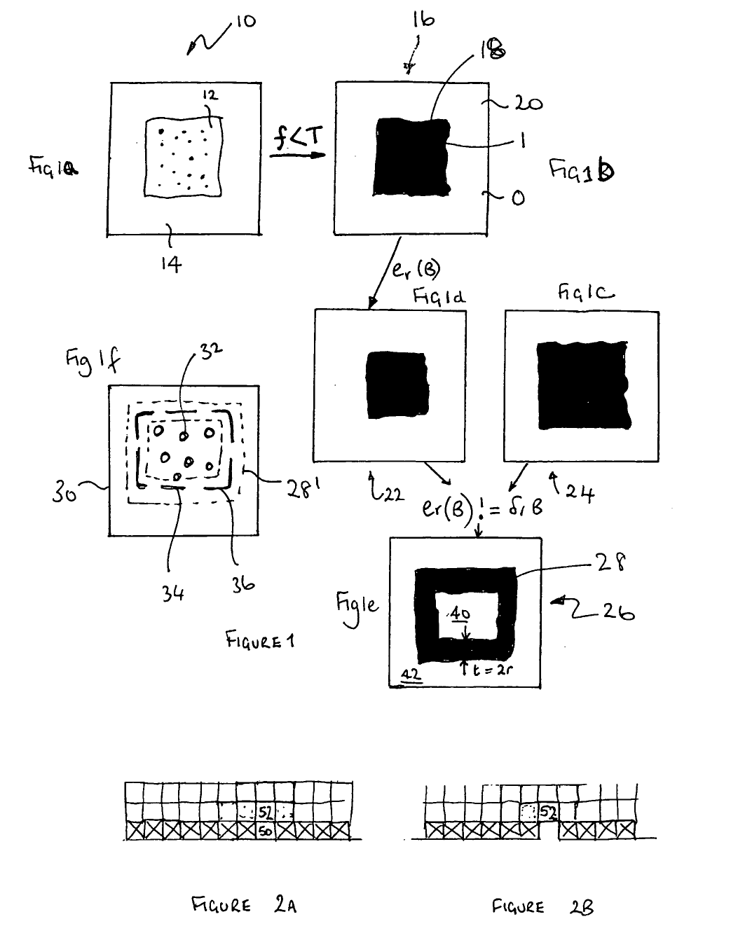

Referring to the drawings, in the method of the present invention, image thresholding of the gel image is first undertaken to provide an approximation of the image boundary as a crude segmentation. In FIG. 1a, a scanned image 10 of a gel 12 against a background 14, which might be a scanner is shown. All parts of the image which are darker than a threshold intensity T are ascribed binary value 1, all other parts of the image are set at binary value 0. This crude binary image includes the gel, the separated background and noise. Next, noise cleaning is first undertaken on the binary image to provide a binary image 16 shown in FIG. 1b that essentially depicts a gel segmented into one group 18 with the background as a second group 20. The group 18 which includes the gel will include the gel and also boundary areas around the gel where shadowing and diffraction makes the background adjacent the edge of the gel look darker than the rest of the background. The threshold T is set to include this shadowed boundary area so that the group 18 is guaranteed to include the edge of the gel.

The cleaned binary image 16 is then put through a morphological edge detection. This is defined as the dilation δr(B) of the cleaned binary image minus the erosion εr(B) of the image using a disk or square structuring element of a specified radius r. The value of r is chosen so that it is comfortably large enough to include the edge and any shadowing but not so large as to include many spots in the gel. Typically, r is 11 to 20 pixels.

FIG. 1c shows the dilation (expansion) of B at 22 and FIG. 1d the erosion of B at 24. Both are binary images having the same shape as the binary gel image 18. The subtraction of the erosion from the expansion produces a thick boundary 28 of width 2r, within which the real boundary is located. This thickened boundary estimate 28 shown at 26 can now be thinned to produce a medial or skeletal boundary as an estimate of the boundary of the gel.

At the same time as the boundary estimate is generated, a traditional local edge detection method (edge(f)=δr1(f)−εr1(f))is used to produce an image with high response values where local intensity changes are highest within the image which occurs on the edges and where the spots in the gel are present. This image is shown in FIG. 1e at 30. In the image there are regions of high intensity changes at 32 where there are spots and at 34 and 36 for example at boundary of the gel. Various known edge detection methods such as Sobel, dilation, erosion or Laplacian can be used. For example, in a Laplacian method, to produce the edge value for a particular pixel, (the “central” pixel) the adjoining pixels intensity values are summed and averaged and the average value subtracted from the intensity value of the central pixel. Essentially, high values are produced where changes in intensity are greatest—which is indicative of a boundary or edge.

Homotopic thinning is then carried out on the image 28. Specifically, this homotopic thinning approach does not change the number of regions in the image during boundary thinning and therefore is guaranteed to keep closed boundaries. For example, in the FIG. 26 there are three regions the inside 40 the thickened boundary region 28 and the outside 42. The algorithm used in homotopic thinning examines each pixel within the thickened boundary region to see if can be removed without altering the homotopy of the image. If it can be removed as described below, it is removed. This process is repeated until no further pixels can be removed without breaking the homotopy.

FIGS. 2a and 2b illustrate homotopic thinning. In FIG. 2a which shows one section of the inner edge of the boundary of the thickened boundary region in which in theory any of the pixels marked with an x or pixel 50, could be removed from the boundary region without creating a new region and destroying the homotopy. If pixel 50 is removed (ie changed from binary 1 to binary 0), pixel 52 is now eligible for removal see FIG. 2b. If pixel 52 is then removed any of the seven pixels surrounding it could also be removed without creating a new region.

In order to determine the edge location most accurately all those pixels that can be removed homotopically at each iteration are ordered, according to their edge element value from an edge thresholding image, as determined from the corresponding location in the edge thresholding image 30 which is grey scale. In FIG. 1f the thickened boundary region 28′ is shown superposed over the edge thresholding image 30. Only the pixel that has the smallest edge value is removed at each iteration. This is the darkest pixel. After each pixel is removed from image 28 any new pixels which can now be homotopically removed are also ordered

The boundary detected by this process will be one that has maximised the minimum value along the contour and has produced a contour that lines up along the strongest edge elements pertaining to the boundary of the gel. It is guaranteed to be continuous as the homotopic thinning process guarantees a connected path. Thus, an optimal contour location is produced. This determination of the gel edged boundary lines up naturally on the most responsive parts of the edge as determined from the edge element image.

Although this method may appear to be computationally intensive, it can be performed extremely quickly using priority queues and neighbourhood analysis. Thus, the method of the present invention offers a fast and repeatable approach to define closed edge boundaries of gels. For further refinement, control smoothing is applied.

The accurate determination of the edge of a gel has many uses and advantages. Once the gel boundary can be accurately located by a computer this allows automated gel calibration of molecular weight and isoelectric point. Molecular weight of spots such as proteins on the gel is a function of the distance the protein has travelled from its start point which will be one edge boundary of the gel. The location of the spot measured transversely across the gel i.e. left to right as oriented in FIG. 1 if the top edge is the start point, will indicate the isoelectric point of the protein.

It will be evident to those practiced in the art that this method may be applied more generally than for this gel boundary identification alone. In particular, the method could be used to determine boundaries of membranes to which arrays of macromolecule spots are transferred such as by electroblotting. The method could be applied more broadly in other image analysis problems where boundary detection is required such as parts identification in assembly line inspection, irregular particle size distribution, medical imaging, etc.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A method for accurately determining the boundaries of an object comprising the steps of:
a) creating a binary image of the object, the binary image having a central region, a boundary region, and an outside region with the boundary region encompassing the boundary of the object; and
b) performing a homotopic thinning of the binary image, iteratively until no more pixels can be removed.

2. A method as claimed in claim 1 wherein the step of performing a homotopic thinning iteration is performed on the binary using information in a grey scale image of the object and an area surrounding the object.

3. A method as claimed in claim 2 wherein the grey scale is an edge threshold image of the object.

4. A method as claimed in claim 1 wherein step (b) comprises the steps of:
bi) producing a grey scale edge image of the object having high response values or intensity where local intensity changes are highest within the image; and
bii) performing a grey scale controlled homotopic thinning of the binary image in which pixels which can be removed homotopicaly from the binary image are ordered and the pixel which is removed is that which corresponds in location to the pixel which has the smallest edge/intensity value in the grey scale edge image of the object.

5. A method as claimed in claim 3 wherein the edge threshold image of the object is produced by a dilation of the binary image minus an erosion of the binary image.

6. A method as claimed in claim 4 wherein the grey scale edge image of the object is produced by a Sobel, dilation/erosion or laplacian method.

7. A method as claimed in claim 1 wherein step a) includes the following steps
ai) creating a crude binary image of the object and cleaning the image to remove noise to provide an image that depicts the object segmented into one group with the background as a second group, with the one group including the object and object boundary areas; and
aii) subtracting an erosion of the binary image from a dilation of the binary image.

8. A method as claimed in claim 1 wherein the object is a gel slab containing macromolecule spots.

9. A method for accurately determining the boundaries of an object comprising the steps of:
a) creating a binary image of the object, the binary image having a central region, a boundary region, and an outside region with the boundary region encompassing the boundary of the object; and
b) producing a grey scale edge image of the object having high response values where local intensity changes are highest within the image; and
c) performing a grey scale controlled homotopic thinning of the binary image in which pixels which can be removed homotopicaly from the binary image are ordered and the pixel which is removed is that which corresponds in location to the pixel which has the smallest edge/intensity value in the grey scale edge image of the object.

10. A method as claimed in claim 9 wherein the grey scale is an edge threshold image of the object.

11. A method as claimed in claim 10 wherein step a) includes the followin steps:
ai) creating a crude binary image of the object and cleaning the image to remove noise to provide an image that depicts the object segmented into one group with the background as a second group, with the one group including the object and object boundary areas; and
aii) subtracting an erosion of the binary image from a dilation of the binary image to create the binary image.

12. A method as claimed in claim 9 wherein the object is a gel slab containing macromolecule spots.

13. A method for accurately determining the boundaries of an object comprising the steps of:
a) creating a crude binary image of the object and cleaning the image to remove noise to provide an image that depicts the object segmented into one group with the background as a second group, with the one group including the object and object boundary areas;
b) subtracting an erosion of the binary image from a dilation of the binary image to create a resultant binary image having a central region, a boundary region, and an outside region with the boundary region encompassing the boundary of the object; and
c) producing a grey scale edge image of the object having high response values where local intensity changes are highest within the image; and
d) performing a grey scale controlled homotopic thinning of the resultant binary image in which pixels which can be removed homotopicaly from the binary image are ordered and the pixel which is removed is that which corresponds in location to the pixel which has the smallest edge/intensity value in the grey scale edge image of the object.

14. A method as claimed in claim 13 wherein the object is a gel slab containing macromolecule spots.
